(19) United States
(12) Patent Application Publication
(10) Pub. No.: US 2023/0215271 A1
(43) Pub. Date: Jul. 6, 2023

(54) VEHICLE CONTROL SYSTEM

(71) Applicant: Mitsubishi Electric Corporation, Tokyo (JP)

(72) Inventors: Takahisa AOYAGI, Tokyo (JP); Kenta KATSU, Tokyo (JP); Takashi MATSUMOTO, Tokyo (JP); Masataka SHIROZONO, Tokyo (JP)

(73) Assignee: Mitsubishi Electric Corporation, Tokyo (JP)

(21) Appl. No.: 17/998,072

(22) PCT Filed: Jun. 5, 2020
(86) PCT No.: PCT/JP2020/022248

§ 371 Date: Nov. 7, 2022

(51) Int. Cl. G08G 1/0967; B60W 60/00

(52) U.S. Cl. CPC G08G 1/096725; B60W 60/001; B60W 2556/40; B60W 2556/45

(57) ABSTRACT

To provide a vehicle control system which can reduce dependence on determination of an automatic driving vehicle and can make the automatic driving vehicle perform evacuation driving under control of the vehicle control system, at the time of occurrence of an evacuation cause. A vehicle control system acquires traveling nodes for automatic driving which makes the object vehicle perform automatic driving from the travel node storage unit, and transmits it to the object vehicle; and irrespective of a presence or absence of occurrence of an evacuation cause for evacuating the object vehicle, acquires the evacuation nodes corresponding to the travel nodes for automatic driving from the evacuation node storage unit, and transmits to the object vehicle.

### TECHNICAL FIELD

The present disclosure is related with a vehicle control system.

### BACKGROUND ART

Recently, the narrow area automatic driving which realizes automatic driving by communicating between the vehicle control system and the automatic driving vehicle has been developed. As its example, the automatic valet parking that, in a parking place which has a plurality of parking areas, the vehicle control system performs a traveling instruction to an automatic driving vehicle, and makes the vehicle perform entering to a specified parking area and leaving from a parking area automatically has been studied (for example, patent document 1).

### CITATION LIST

### Patent Literature

Patent document 1: JP 2019-164698 A

### SUMMARY OF INVENTION

### Technical Problem

When a communication failure between the vehicle control system and the automatic driving vehicle, a system abnormality of the vehicle control system itself, a system abnormality of the automatic driving vehicle itself, and the like occurs, it becomes impossible to control the corresponding vehicle by the vehicle control system. Accordingly, it is considered to stop the corresponding vehicle urgently. However, by stopping the vehicle urgently, it becomes disturbance of passage of other vehicles in the control area, and the function of the vehicle control system is deteriorated.

To this kind problem, the technology of the patent document 1 proposes to determine an evacuation position in real time on the vehicle side, by communicating between the control center and the automatic driving vehicle during valet parking execution. However, there are following problems. A sensor of the vehicle side is used for determining the evacuation position, and the evacuation place is limited in a sensor reception range. A sensor of the vehicle side is used for determining the evacuation position, and dependence on the vehicle is caused (the evacuation place can be detected or cannot be detected, depending on the vehicle). It is necessary to determine the evacuation position in real time, and the computation load of the vehicle side increases. When communication failure occurs after the vehicle determines the evacuation position and until the vehicle informs its position information to the control center via communication, the control center may be unable to grasp the new evacuation place.

Then, the purpose of the present disclosure is to provide a vehicle control system which can reduce dependence on determination of an automatic driving vehicle and can make the automatic driving vehicle perform evacuation driving under control of the vehicle control system, at the time of occurrence of an evacuation cause.

### Solution to Problem

A vehicle control system according to the present disclosure, including:
a communication unit that communicates with an object vehicle which performs an automatic traveling in a control area for controlling;
a map information storage unit that stores map information of the control area;
a travel node storage unit that stores travel nodes for performing an automatic driving, in the control area;
an evacuation node storage unit that stores evacuation nodes for making a vehicle evacuate from the travel nodes and stop in an emergency, in the control area;
a vehicle state management unit that
   monitors a vehicle state including the object vehicle in the control area,
   acquires the map information of the control area from the map information storage unit,
   acquires the travel nodes for automatic driving which makes the object vehicle perform the automatic driving from the travel node storage unit, based on the vehicle state and the map information of the control area, and transmits to the object vehicle via a communication unit, and
   acquires the evacuation nodes which makes the object vehicle evacuate from the evacuation node storage unit, and transmits to the object vehicle via the communication unit,
wherein, irrespective of a presence or absence of occurrence of an evacuation cause for evacuating the object vehicle, the vehicle state management unit acquires the evacuation nodes corresponding to the travel nodes for automatic driving from the evacuation node storage unit, and transmits to the object vehicle.

### Advantage of Invention

According to the vehicle control system of the present disclosure, irrespective of the presence or absence of occurrence of the evacuation cause, by transmitting the evacuation nodes corresponding to the traveling nodes for automatic driving to the object vehicle, the object vehicle can be quickly evacuated to the evacuation nodes after occurrence of the evacuation cause, without waiting for transmission of the evacuation nodes from the vehicle control system. For example, even if communication failure occurs and communication becomes impossible between the vehicle control system and the object vehicle, the object vehicle can evacuate to the appropriate evacuation place. Since these evacuation nodes are transmitted by the vehicle control system, the dependence on determination of the automatic driving vehicle can be reduced, and the automatic driving vehicle can be made to perform the evacuation driving appropriately under control of the vehicle control system, at the time of occurrence of the evacuation cause. Accordingly, it can suppress becoming the disturbance of passage of other vehicles in the control area, by evacuation of the vehicle, and it can suppress deterioration of function of the vehicle control system.

### BRIEF DESCRIPTION OF THE DRAWINGS

FIG. 1 is a schematic block diagram of the vehicle control system according to Embodiment 1;

FIG. 2 is a figure explaining the automatic valet parking system according to Embodiment 1;

FIG. 3 is a hardware configuration figure of the vehicle control system according to Embodiment 1;

FIG. 4 is a hardware configuration figure of the vehicle control system according to Embodiment 1;

FIG. 5 is a flowchart for explaining the entering processing according to Embodiment 1;

FIG. 6 is a flowchart for explaining the entering starting processing according to Embodiment 1;

FIG. 7 is a flowchart for explaining the entering guiding processing according to Embodiment 1;

FIG. 8 is a figure explaining transmission of the evacuation nodes according to Embodiment 1;

FIG. 9 is a flowchart for explaining the evacuation processing according to Embodiment 1;

FIG. 10 is a figure explaining the evacuation processing according to Embodiment 1;

FIG. 11 is a flowchart for explaining the leaving processing according to Embodiment 1;

FIG. 12 is a flowchart for explaining the leaving starting processing according to Embodiment 1;

FIG. 13 is a flowchart for explaining the leaving guiding processing according to Embodiment 1;

FIG. 14 is a figure explaining transmission of the evacuation nodes according to Embodiment 2;

FIG. 15 is a figure explaining transmission of the evacuation nodes according to Embodiment 3; and

FIG. 16 is a schematic block diagram of the vehicle control system according to Embodiment 4.

### DETAILED DESCRIPTION OF THE EMBODIMENTS

### 1. Embodiment 1

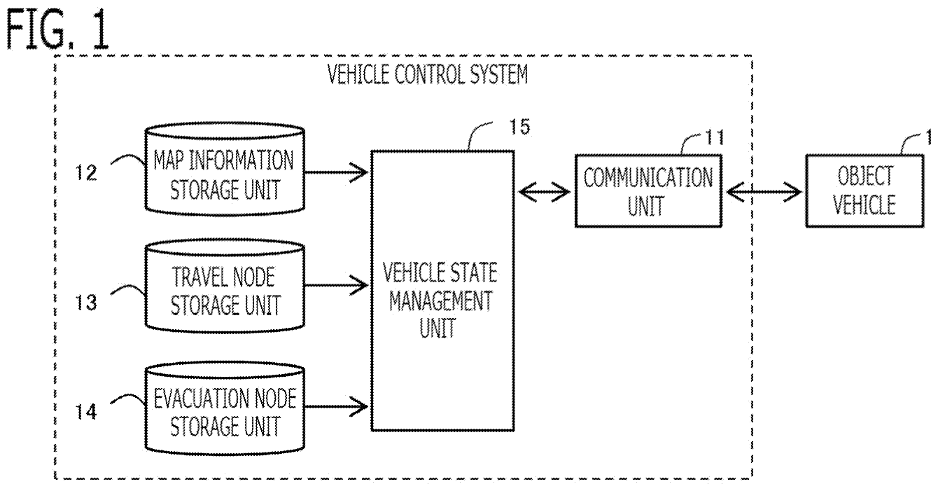

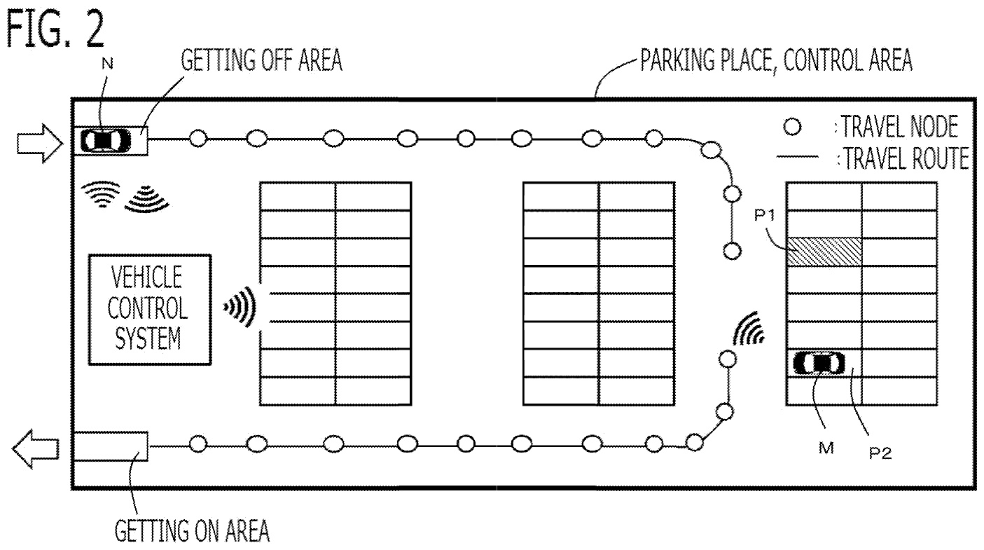

A vehicle control system according to Embodiment 1 will be explained with reference to drawings. FIG. 1 is a schematic block diagram of the vehicle control system. In the present embodiment, the vehicle control system controls a vehicle in an automatic valet parking system as shown in FIG. 2.

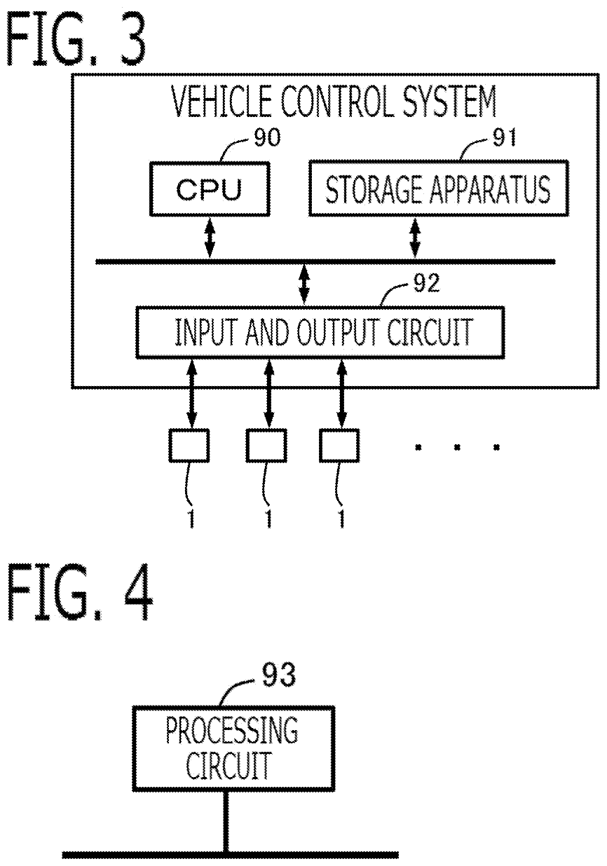

The vehicle control system is provided with functional units of a communication unit 11, a map information storage unit 12, a travel node storage unit 13, an evacuation node storage unit 14, a vehicle state management unit 15, and the like. Each function of the vehicle control system is realized by processing circuits provided in the vehicle control system. As shown in FIG. 3, specifically, the vehicle control system is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), a hard disk, and a DVD apparatus, are used.

The input and output circuit 92 is provided with a communication device, an A/D converter, a driving circuit, and the like. The input and output circuit 92 communicates with a vehicle which exists in a control area for controlling via a wireless communication apparatus and the like. The input and output circuit 92 may communicate with a plurality of monitoring sensors via a cable or a wireless communication apparatus.

Then, the arithmetic processor 90 runs software items (programs) stored in the storage apparatus 91 and collaborates with other hardware devices in the vehicle control system, such as the storage apparatus 91, and the input and output circuit 92, so that the respective functions of the functional units 11 to 15 provided in the vehicle control system are realized. Storage data, such as the map information of the map information storage unit 12, the travel nodes of the travel node storage unit 13, and the evacuation nodes of the evacuation node storage unit 14, is stored in the storage apparatus, such as a hard disk. Setting data utilized in the functional units 11 to 15 are stored, as part of software items (programs), in the storage apparatus 91. Hereinafter, each function of the vehicle control system will be explained in detail.

Alternatively, as shown in FIG. 4, the vehicle control system may be provided with a dedicated hardware 93 as the processing circuit, for example, a single circuit, a combined circuit, a programmed processor, a parallel programmed processor, ASIC, FPGA, GPU, AI chip, or a circuit which combined these.

### Basic Schematic Configuration of Automatic Valet Parking System

First, the basic schematic configuration of the automatic valet parking system which uses the vehicle control system will be explained. As shown in FIG. 2, the automatic valet parking system is provided in a parking place which has a plurality of parking areas. An object vehicle controlled by the vehicle control system mounts an automatic driving apparatus. When a vehicle entered at an entrance (a getting off area) of the parking place, a vehicle control system determines a parking area of the entered object vehicle, and a plurality of travel nodes to the parking area, and transmits the plurality of travel nodes to the object vehicle; and makes the object vehicle perform an automatic driving along with the plurality of travel nodes and park in the parking area.

On the other hand, when a vehicle is made to leave from the parking place, the vehicle control system determines a plurality of travel nodes from the parking area of the object vehicle which is made to leave to an exit (a getting on area), and transmits the plurality of travel nodes to the object vehicle; and makes the object vehicle performs automatic driving along with the plurality of travel nodes, and guides to the exit.

For example, as shown in FIG. 2, when the vehicle N arrived at the getting off area which is the entrance of the parking place, the vehicle control system tries communication with the vehicle N. When the communication is established, the vehicle control system acquires vehicle information of the vehicle N from the vehicle N. For example, a vehicle type, a vehicle width, and a vehicle height are included in the vehicle information. The vehicle control system determines an optimal parking area P1, based on the vehicle information of the vehicle N, the empty state of each parking area of the parking place, and the information on each parking area (for example, the vehicle type, the vehicle width, the vehicle height which can be parked), and transmits it to the vehicle N. At the same time, the vehicle control system determines a plurality of travel nodes from the getting off area to the parking area P1, and transmits it to the vehicle N.

The vehicle N calculates a travel route from the getting off area to the parking area P1, based on the plurality of travel nodes. The vehicle N informs the vehicle control system that the travel route can be calculated. When the vehicle control system confirms its notice, the vehicle control system informs an instruction of parking start to the vehicle N. When the vehicle N receives its notice, the vehicle N switches to the automatic driving mode, and starts traveling to the parking area P1 by automatic driving. The vehicle N communicates with the vehicle control system periodically during traveling of automatic driving to the parking area P1, and transmits a point (a node) where the vehicle N is traveling currently to the vehicle control system.

The vehicle control system is monitoring states of all vehicles including the vehicle N which exist in the parking place. Based on the vehicle state, the vehicle control system informs a stop instruction to the object vehicle, and informs an instructions of route change, as needed.

Next, when the vehicle N arrived at the parking area P1 and the parking is completed, the vehicle N informs completion of parking to the vehicle control system. The above is the basic operation procedures in entering of the automatic valet parking system.

Next, the procedure of leaving will be explained. When the vehicle control system receives a leaving requirement of the vehicle M parked at the parking area P2, the vehicle control system tries communication with the vehicle M. When the communication is established, the vehicle control system transmits a getting on area which is an exit of the parking place, to the vehicle M, based on the vehicle information of the vehicle M acquired at the time of entering. At the same time, the vehicle control system determines a plurality of travel nodes from the parking place to the getting on area, and transmits it to the vehicle M.

The vehicle M calculates a travel route from the parking area P2 to the getting on area, based on the plurality of travel nodes. The vehicle M informs the vehicle control system that the travel route can be calculated. When the vehicle control system confirms its notice, the vehicle control system informs an instruction of leaving start to the vehicle M. When the vehicle M receives its notice, the vehicle M switches to the automatic driving mode, and starts traveling to the getting on area by automatic driving. The vehicle M communicates with the vehicle control system periodically during traveling of automatic driving to the getting on area, and transmits a point (a node) where the vehicle N is traveling currently to the vehicle control system.

The vehicle control system is monitoring states of all vehicles including the vehicle N which exist in the parking place. Based on the vehicle state, the vehicle control system informs a stop instruction to the object vehicle, and informs an instructions of route change, as needed.

Next, when the vehicle M arrived at the getting on area, the vehicle M informs completion of leaving to the vehicle control system. The above is the basic operation procedures in leaving of the automatic valet parking system.

### Vehicle

The vehicle which is set as the object for control by the vehicle control system is the vehicle which can perform automatic driving and can communicate with the vehicle control system. The vehicle is provided with an automatic driving apparatus and a communication device. The automatic driving apparatus is provided with a communication device which communicates with the outside, such as the vehicle control system; a position detection apparatus which detects a vehicle position; a periphery monitoring apparatus which monitors periphery of the vehicle; a power apparatus which changes a driving force and a braking force of the vehicle; a steering apparatus which changes a steering angle of the vehicle; and a traveling control apparatus which determines a travel route of the vehicle and controls the power apparatus and the steering apparatus so that the vehicle travels along with the travel route. The wireless communication apparatus of cellular system, such as 4G, and 5G is used for the communication device. A global positioning system (GPS) and the like are used for the position detection apparatus. A camera, a radar, and the like are used for the periphery monitoring apparatus. The traveling control apparatus determines a travel route, based on a guide route to a destination point determined by a navigation function or the plurality of travel nodes transmitted from the vehicle control system, the map information, the current position of the vehicle detected by the position detection apparatus, and the peripheral state detected by the periphery monitoring apparatus. Then, the traveling control apparatus controls the power apparatus and the steering apparatus so that the vehicle follows and travels along with the travel route.

### Communication Unit 11

The communication unit 11 communicates with the object vehicle 1 which performs an automatic traveling in the control area for controlling. The communication unit 11 uses the communication device provided in the input and output circuit 92 as a core apparatus. The wireless communication apparatus of cellular system, such as 4G and 5G is used for the communication device. In the present embodiment, since the control area is the parking place, the communication unit 11 communicates with the vehicle which exists in the parking place.

### Management of Vehicle State in Control Area

The vehicle state management unit 15 monitors a vehicle state including the object vehicle in the control area. The vehicle state management unit 15 communicates with the vehicle located in the control area via the communication unit 11, and acquires information on the current position of the object vehicle 1, and vehicle information (the vehicle type, the vehicle width, the vehicle height, and the like). The vehicle state management unit 15 communicates with all vehicles which exist in the control area periodically, and acquires information on the current position, and the vehicle information. And, when the vehicle arrived at the entrance of the control area (the parking place), the vehicle state management unit 15 communicates with the vehicle, and acquires the vehicle information.

The vehicle state management unit 15 manages the traveling state and the parking state of all vehicles in the control area. In the present embodiment, the vehicle state management unit 15 manages a presence or absence of parking vehicle in each parking area of the parking place, and a moving state of vehicle in the parking place.

### Map Information Storage Unit 12

The map information storage unit 12 stores map information of the control area. In the present embodiment, since the control area is the parking place, the map information storage unit 12 stores information on arrangement, shape, and the like of each parking area of the parking place; information on each parking area (for example, the vehicle type, the vehicle width, the vehicle height which can be parked); information on position, shape, and the like of passage where the vehicle can travel; and information on traffic regulation in the parking place, such as lane, stop line, travel direction, and route.

If the control area is not the parking place but the general road, the map information storage unit 12 stores road information, such as shape and lane of road, sign, and signal.

### Travel Node Storage Unit 13

The travel node storage unit 13 stores travel nodes for performing an automatic driving, in the control area. A line which connects the travel nodes becomes a travel route. Each travel node has position information, such as latitude and longitude. Basically, the travel node is set on the assumption that the right and left center of vehicle passes the travel node.

In the present embodiment, the travel node storage unit 13 stores a plurality of travel nodes which are set along with the passage where the vehicle can travel in the parking place. For example, the travel node storage unit 13 stores a plurality of travel nodes for guiding from the entrance to each parking area. The travel node storage unit 13 stores a plurality of travel nodes for guiding from each parking area to the exit of the parking place.

### Evacuation Node Storage Unit 14

The evacuation node storage unit 14 stores evacuation nodes for making a vehicle evacuate from the travel nodes and stop in an emergency, in the control area. For example, the evacuation node is set to a point which does not become disturbance of traveling of the vehicle which travels along with the plurality of travel nodes stored in the travel node storage unit 13. The evacuation node is set to an area on the right side or the left side of the vehicle which travels along with the plurality of travel nodes, for example, the side strip of road. The evacuation node is set to a free space where the vehicle can evacuate, for example, the evacuation area of road.

In the present embodiment, the evacuation node is set to the left end or the right end of the passage where the vehicle can travel in the parking place. The evacuation node is set to an evacuation area provided for evacuation of vehicle in the parking place.

### Details of Entering Processing

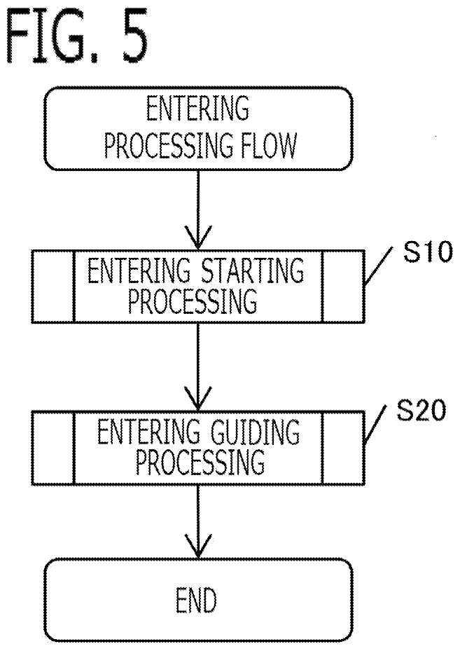

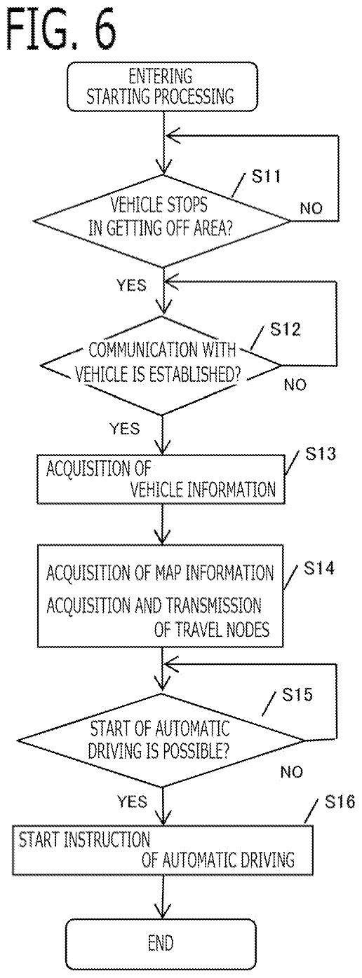

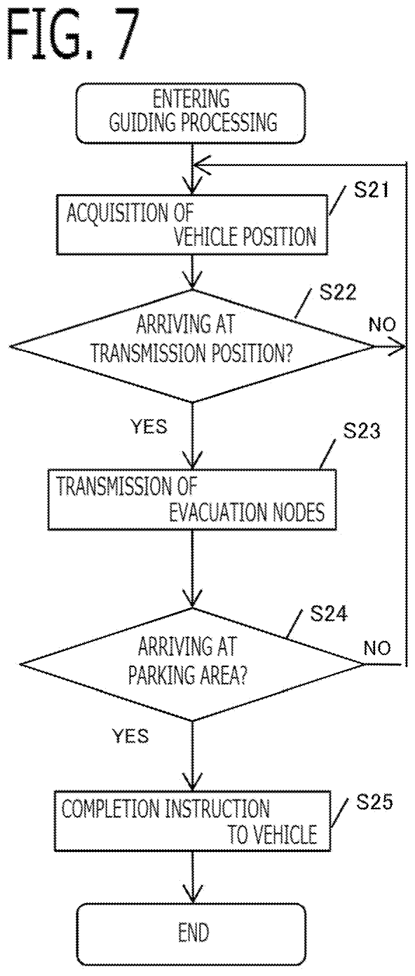

First, the entering processing will be explained with reference to the flowchart shown in FIG. 5 to FIG. 7. The vehicle control system starts an entering starting processing of the step S10 of FIG. 5. The details of the entering starting processing of the step S10 is shown in the flowchart of FIG. 6. After the end of the entering starting processing of the step S10 of FIG. 5, the vehicle control system starts an entering guiding processing of the step S20 of FIG. 5. The details of the entering guiding processing of the step S20 is shown in the flowchart of FIG. 7.

After the start of the entering starting processing, in the step S11 of FIG. 6, the vehicle state management unit 15 determines whether or not the vehicle stops in the getting off area which is the entrance of the parking place. For example, the vehicle state management unit 15 determines a presence or absence of a stop of the vehicle, based on a signal of a monitoring sensor (a camera, a vehicle sensing sensor, and the like) installed in the getting off area.

When determining that the vehicle stops in the getting off area, the vehicle state management unit 15 advances to the step S12, and tries communication with the vehicle stopping in the getting off area via the communication unit 11. Then, when the communication with the vehicle can be established, the vehicle state management unit 15 sets this vehicle as the object vehicle 1 that the vehicle control system controls, and advances to the step S13.

Then, in the step S13, the vehicle state management unit 15 acquires vehicle information (the vehicle type, the vehicle width, the vehicle height, and the like) from the object vehicle 1 stopping in the getting off area via the communication unit 11.

Next, in the step S14, the vehicle state management unit 15 acquires map information of the control area (the parking place) from the map information storage unit 12. The vehicle state management unit 15 acquires the traveling nodes for automatic driving which makes the object vehicle 1 perform automatic driving, from the travel node storage unit 13, based on the monitored vehicle state in the control area, and map information of the control area, and transmits it to the object vehicle 1 via the communication unit 11.

In the present embodiment, the vehicle state management unit 15 determines a parking area of the object vehicle 1 (hereinafter, referred to as a guiding parking area), based on the presence or absence of parking vehicle in each parking area. The vehicle state management unit 15 determines the guiding parking area of the object vehicle 1, based on the presence or absence of parking vehicle in each parking area, information on each parking area (for example, the vehicle type, vehicle width, vehicle height which can be parked), and vehicle information of the object vehicle 1 (the vehicle type, the vehicle width, the vehicle height, and the like).

Then, the vehicle state management unit 15 acquires a plurality of travel nodes for automatic driving which makes the object vehicle 1 perform automatic driving from the entrance of parking place to the guiding parking area, from the travel node storage unit 13. At this time, the vehicle state management unit 15 evaluates a plurality of conditions, such as a condition that a travel route does not overlap with the other vehicle which is traveling in the control area, a condition that a travel distance becomes short, and a condition that driving becomes easy, and acquires a plurality of desirable travel nodes from the travel node storage unit 13. Then, the vehicle state management unit 15 transmits the plurality of determined travel nodes for automatic driving to the object vehicle 1 via the communication unit 11.

Then, in the step S15, the object vehicle 1 which received the traveling nodes for automatic driving calculates a travel route, based on the traveling nodes for automatic driving. When the preparation for starting automatic driving is completed, the object vehicle 1 transmits that to the vehicle control system.

In the step S16, the vehicle state management unit 15 receives the notice that the preparation of automatic traveling is completed via the communication unit 11 from the object vehicle 1, and transmits a start instruction of automatic driving to the object vehicle 1 via the communication unit 11, after confirming. The object vehicle 1 starts automatic driving, when the start instruction is received. By the above, the entering starting processing of the step S10 of FIG. 5 is ended, and the entering guiding processing of the step S20 is started.

After start of the entering guiding processing, in the step S21 of FIG. 7, the vehicle state management unit 15 communicates with the object vehicle 1 periodically, and acquires information on the current position of the object vehicle 1. Then, in the step S22, the vehicle state management unit 15 determines whether or not the object vehicle 1 arrived at a position for transmitting the evacuation nodes. When determining that it arrived at the transmission position, it advances to the step S23, and when determining that it did not arrive at the transmission position, it advances to the step S21.

In the step S23, the vehicle state management unit 15 acquires the evacuation nodes which makes the object vehicle 1 evacuate, from the evacuation node storage unit 14, and transmits it to the object vehicle 1 via the communication unit 11. Irrespective of a presence or absence of occurrence of an evacuation cause for evacuating the object vehicle 1, the vehicle state management unit 15 acquires the evacuation nodes corresponding to the traveling nodes for automatic driving, from the evacuation node storage unit 14, and transmits it to the object vehicle 1.

Then, in the step S24, the vehicle state management unit 15 determines whether or not the object vehicle 1 arrived at the guiding parking area. When it arrived, it advances to the step S25. When it did not arrive, it returns to the step S21, and performs acquisition of information on the current position of the object vehicle 1, and transmission of the evacuation nodes, repeatedly. In the step S25, the vehicle state management unit 15 performs a completion instruction to the object vehicle 1, and ends the entering guiding processing.

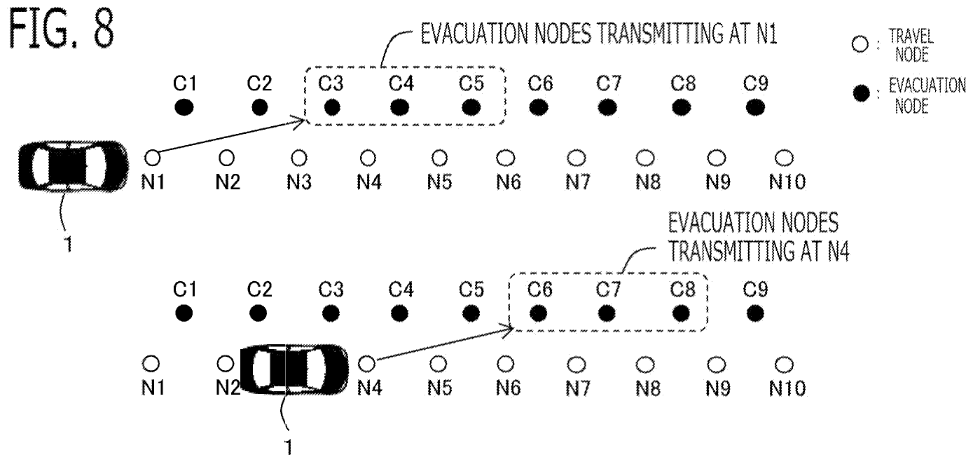

FIG. 8 is a schematic diagram explaining transmission of the evacuation nodes. The vehicle state management unit 15 transmits the evacuation nodes in a distance range located ahead by a set distance from the current position of the object vehicle 1, to the object vehicle 1, whenever the object vehicle 1 travels a determination distance along with the traveling nodes for automatic driving. In FIG. 8, positions where the evacuation nodes are transmitted are the travel nodes N1 and N4. In FIG. 8, at the time when the object vehicle 1 reached the travel node N1, the vehicle state management unit 15 transmits the evacuation nodes C3, C4, and C5 corresponding to the traveling nodes for automatic driving N3 to N6 which are located ahead by the set distance from the travel node N1. At the time point when the object vehicle 1 reached the travel node N4, the vehicle state management unit 15 transmits the evacuation nodes C6, C7, and C8 corresponding to the traveling nodes for automatic driving N6 to N9 which are located ahead by the set distance from the travel node N4.

In this way, irrespective of the presence or absence of occurrence of the evacuation cause, by transmitting the evacuation nodes located ahead from the current position, the object vehicle 1 can be quickly evacuated to the evacuation nodes after occurrence of the evacuation cause, without waiting for transmission of the evacuation nodes from the vehicle control system. For example, even if communication failure occurs and communication becomes impossible between the vehicle control system and the object vehicle 1, the object vehicle 1 can evacuate to the appropriate evacuation place.

The timing when the vehicle state management unit 15 transmits the evacuation nodes, and the number of the evacuation nodes transmitted at once are arbitrary. For example, when the traveling nodes for automatic driving are transmitted to the object vehicle 1 at the start of entering, the vehicle state management unit 15 may transmit all evacuation nodes corresponding to the traveling nodes for automatic driving, to the object vehicle 1.

### Evacuation Processing

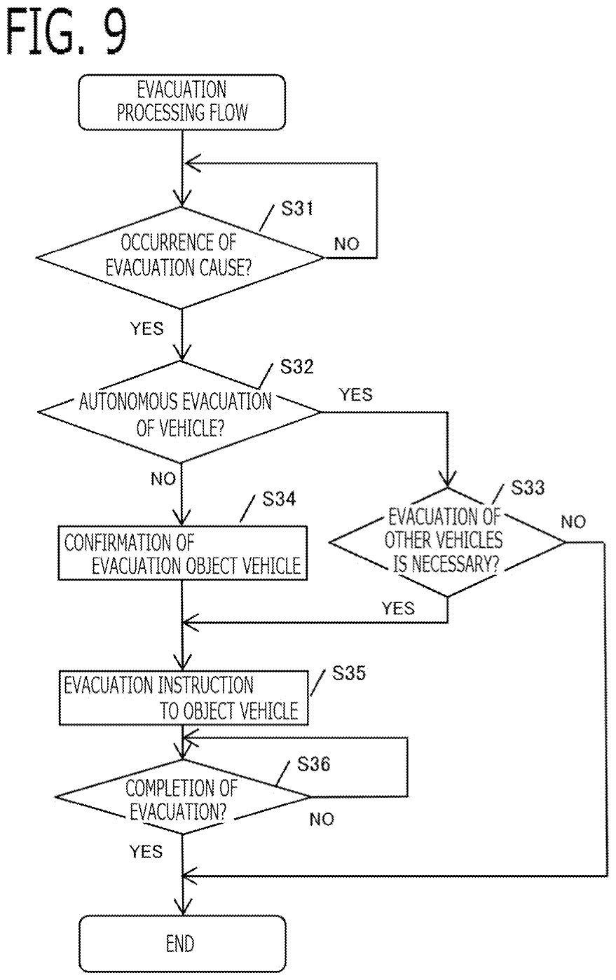

The evacuation processing will be explained with reference to the flowchart shown in FIG. 9. In the step S31, the vehicle state management unit 15 determines whether or not an evacuation cause for evacuating the object vehicle occurred. When the evacuation cause occurs, it advances to the step S32. In the step S32, the vehicle state management unit 15 confirms the evacuation cause, and when it is autonomous evacuation by the object vehicle 1, it advances to the step 33.

As the autonomous evacuation by the object vehicle 1, the object vehicle 1 may detect an obstacle on the travel route by a peripheral monitoring sensor, and the object vehicle 1 may evacuate autonomously. In this case, if the object vehicle 1 can evacuate to the evacuation nodes transmitted beforehand, the object vehicle 1 performs automatic driving for evacuating to the evacuation nodes. If the object vehicle 1 cannot evacuate to the evacuation nodes for some reason, the object vehicle 1 evacuates autonomously considering the vehicle peripheral condition. In that case, in the step S33, the vehicle state management unit 15 acquires information on the current position of the evacuated object vehicle 1. The vehicle state management unit 15 determines influence on other object vehicles 1, based on the position of the evacuated object vehicle 1. When it is necessary to evacuate other object vehicles, it advances to the step S35 and performs evacuation instructions to other object vehicles 1. Other object vehicles 1 perform automatic driving for evacuating to the evacuation nodes transmitted beforehand. Then, in the step S36, the vehicle state management unit 15 acquires information on the current position of other evacuated object vehicles 1. When determining that evacuation is completed, it ends the evacuation processing.

In the step S32, when the evacuation cause is not autonomous evacuation by the object vehicle 1, the vehicle state management unit 15 advances to the step 34. As a case where it is not autonomous evacuation by the object vehicle 1, there is an evacuation due to a factor on the vehicle control system side. If the traveling nodes for automatic driving of the plurality of object vehicles overlaps mutually due to some factor, it is necessary to evacuate one object vehicle. In the step S34, the vehicle state management unit 15 determines the object vehicle 1 required to evacuate. Then, in the step S35, the vehicle state management unit 15 performs evacuation instruction to the determined object vehicle 1. The object vehicle 1 performs automatic driving for evacuating to the evacuation nodes transmitted beforehand. Then, in the step S36, the vehicle state management unit 15 acquires the information on the current position of the evacuated object vehicle 1. When determining that evacuation is completed, it ends the evacuation processing.

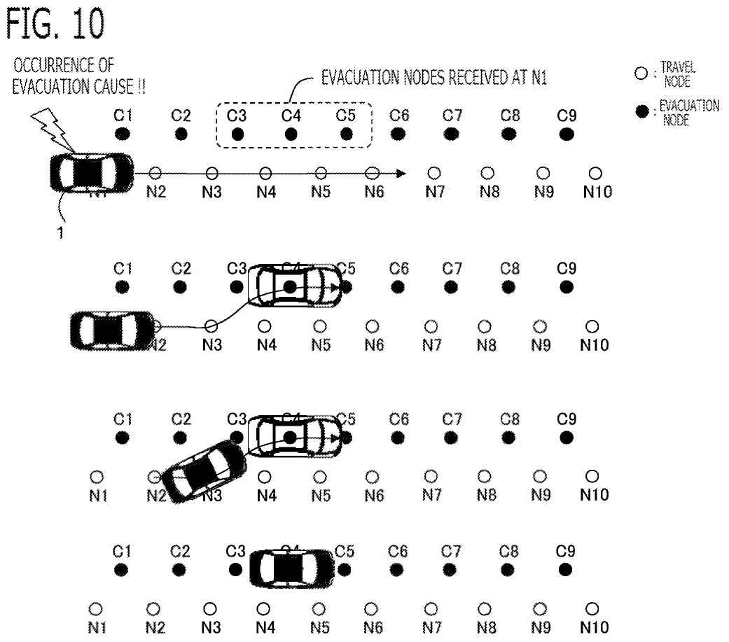

FIG. 10 shows flow of the evacuation processing. As shown in the first row of FIG. 10, when the object vehicle 1 is performing the automatic driving along with the traveling nodes for automatic driving, the evacuation cause occurs. As the evacuation cause, there is the evacuation instruction from the vehicle control system or the autonomous evacuation of the object vehicle 1. As shown in the second row of FIG. 10, when the evacuation cause occurs, the object vehicle 1 calculates a travel route for travelling toward the evacuation node C5 which is the shortest and enables calculation of a route among the evacuation nodes transmitted beforehand from the vehicle control system; and changes the travel route.

As shown in the third row and the fourth row of FIG. 10, the object vehicle 1 controls steering so as to travel along with the travel route toward the evacuation node C5, and stops at the evacuation node C5. In this way, since the route for the traveling nodes for automatic driving is secured by stopping at the evacuation node, it becomes possible to evacuate without disturbing passage of the succeeding vehicle.

### Details of Leaving Processing

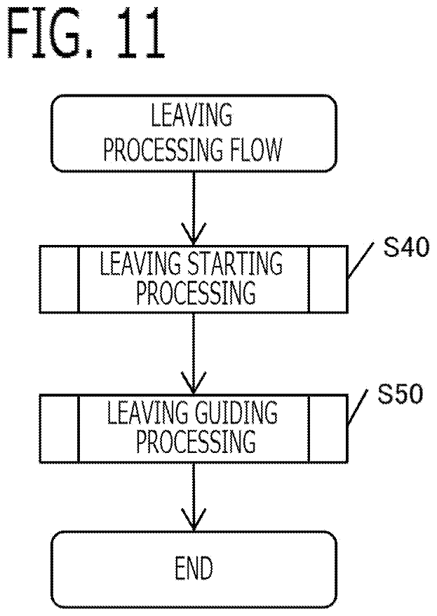

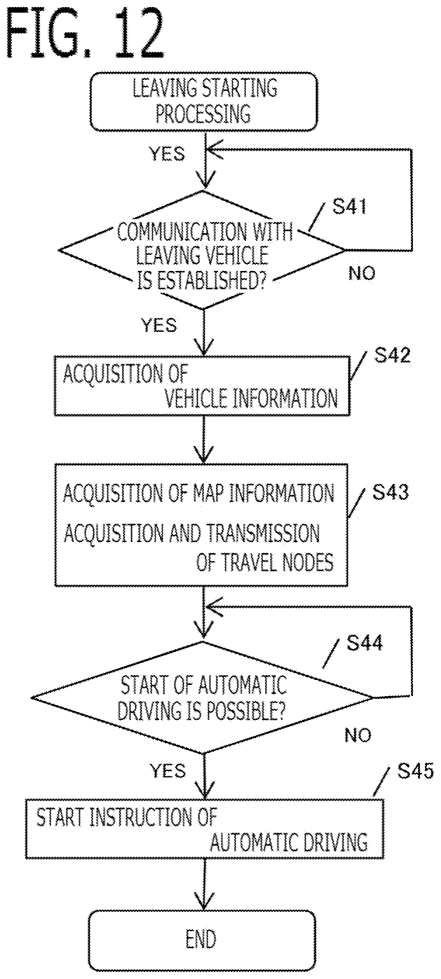

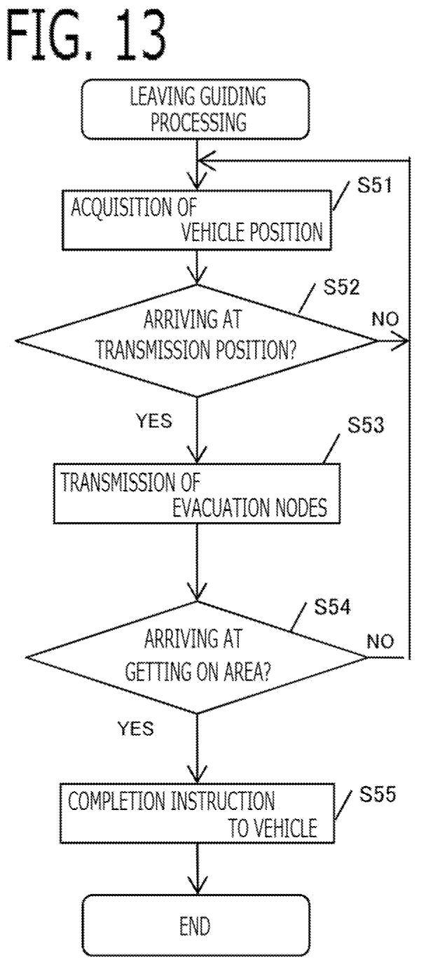

Next, the leaving processing will be explained with reference to the flowchart shown in FIG. 11 to FIG. 13. The vehicle control system starts a leaving starting processing of the step S40 of FIG. 11. The details of the leaving starting processing of the step S40 is shown in the flowchart of FIG. 12. After the end of the leaving starting processing of the step S40 of FIG. 11, the vehicle control system starts a leaving guiding processing of the step S50 of FIG. 11. The details of the entering guiding processing of the step S50 is shown in the flowchart of FIG. 13.

After the start of the leaving starting processing, in the step S41 of FIG. 12, the vehicle state management unit 15 tries communication with the vehicle which stopped in the parking area and performs leaving, via the communication unit 11. Then, when the communication with the vehicle can be established, the vehicle state management unit 15 sets the vehicle as the object vehicle 1 that the vehicle control system controls, and advances to the step S42.

Then, in the step S42, the vehicle state management unit 15 acquires vehicle information (the vehicle type, the vehicle width, the vehicle height, and the like) from the object vehicle 1, via the communication unit 11.

Next, in the step S43, the vehicle state management unit 15 acquires map information of the control area (the parking place) from the map information storage unit 12. The vehicle state management unit 15 acquires the traveling nodes for automatic driving which makes the object vehicle 1 perform automatic driving, from the travel node storage unit 13, based on the monitored vehicle state in the control area, and map information of the control area, and transmits it to the object vehicle 1 via the communication unit 11.

In the present embodiment, the vehicle state management unit 15 acquires a plurality of travel nodes for automatic driving which makes the object vehicle 1 perform automatic driving from the parking area where the object vehicle 1 stops to the exit (the getting on area) of the parking place, from the travel node storage unit 13. At this time, the vehicle state management unit 15 evaluates a plurality of conditions, such as a condition that a travel route does not overlap with the other vehicle which is traveling in the control area, a condition that a travel distance becomes short, and a condition that driving becomes easy, and acquires a plurality of desirable travel nodes from the travel node storage unit 13. Then, the vehicle state management unit 15 transmits the plurality of determined travel nodes for automatic driving to the object vehicle 1 via the communication unit 11.

Then, in the step S44, the object vehicle 1 which received the traveling node for automatic driving calculates a travel route, based on the traveling node for automatic driving. When the preparation for starting automatic driving is completed, the object vehicle 1 transmits that to the vehicle control system.

In the step S45, The vehicle state management unit 15 receives the notice that the preparation of automatic traveling is completed via the communication unit 11 from the object vehicle 1, and transmits a start instruction of automatic driving to the object vehicle 1 via the communication unit 11, after confirming. The object vehicle 1 starts automatic driving, when the start instruction is received. By the above, the leaving starting processing of the step S40 of FIG. 11 is ended, and the leaving guiding processing of the step S50 is started.

After start of the leaving guiding processing, in the step S51 of FIG. 13, the vehicle state management unit 15 communicates with the object vehicle 1 periodically, and acquires information on the current position of the object vehicle 1. Then, in the step S52, the vehicle state management unit 15 determines whether or not the object vehicle 1 arrived at a position for transmitting the evacuation nodes. When determining that it arrived at the transmission position, it advances to the step S53, and when determining that it did not arrive at the transmission position, it advances to the step S51.

In the step S53, the vehicle state management unit 15 acquires the evacuation nodes which make the object vehicle 1 evacuate, from the evacuation node storage unit 14, and transmits it to the object vehicle 1 via the communication unit 11. Irrespective of a presence or absence of occurrence of an evacuation cause for evacuating the object vehicle 1, the vehicle state management unit 15 acquires the evacuation nodes corresponding to the traveling nodes for automatic driving, from the evacuation node storage unit 14, and transmits it to the object vehicle 1.

Then, in the step S54, the vehicle state management unit 15 determines whether or not the object vehicle 1 arrived at the exit (the getting on area) of the parking place. When it arrived, it advances to the step S55. When it did not arrive, it returns to the step S51, and performs acquisition of information on the current position of the object vehicle 1, and transmission of the evacuation node, repeatedly. In the step S55, the vehicle state management unit 15 performs a completion instruction to the object vehicle 1, and ends the leaving guiding processing.

Similarly to the entering time explained using FIG. 8, the vehicle state management unit 15 transmits the evacuation nodes in a distance range located ahead by a set distance from the current position of the object vehicle 1, to the object vehicle 1, whenever the object vehicle 1 travels a determination distance along with the traveling nodes for automatic driving.

Even in the leaving, irrespective of the presence or absence of occurrence of the evacuation cause, by transmitting the evacuation nodes located ahead from the current position, the object vehicle 1 can be quickly evacuated to the evacuation nodes after occurrence of the evacuation cause, without waiting for transmission of the evacuation nodes from the vehicle control system. For example, even if communication failure occurs and communication becomes impossible between the vehicle control system and the object vehicle 1, the object vehicle 1 can evacuate to the appropriate evacuation place.

The timing when the vehicle state management unit 15 transmits the evacuation nodes, and the number of the evacuation nodes transmitted at once are arbitrary. For example, when the traveling nodes for automatic driving are transmitted to the object vehicle 1 at the start of leaving, the vehicle state management unit 15 may transmit all evacuation nodes corresponding to the traveling nodes for automatic driving, to the object vehicle 1.

Since the details of the evacuation processing during leaving are similar to the evacuation processing during entering explained using FIG. 9 and FIG. 10, explanation is omitted.

### 2. Embodiment 2

Next, the vehicle control system according to Embodiment 2 will be explained. The explanation for constituent parts the same as those in Embodiment 1 will be omitted. The basic configuration and processing of the vehicle control system according to the present embodiment are the same as those of Embodiment 1. In the present embodiment, the determining method of the evacuation nodes is partially different from Embodiment 1.

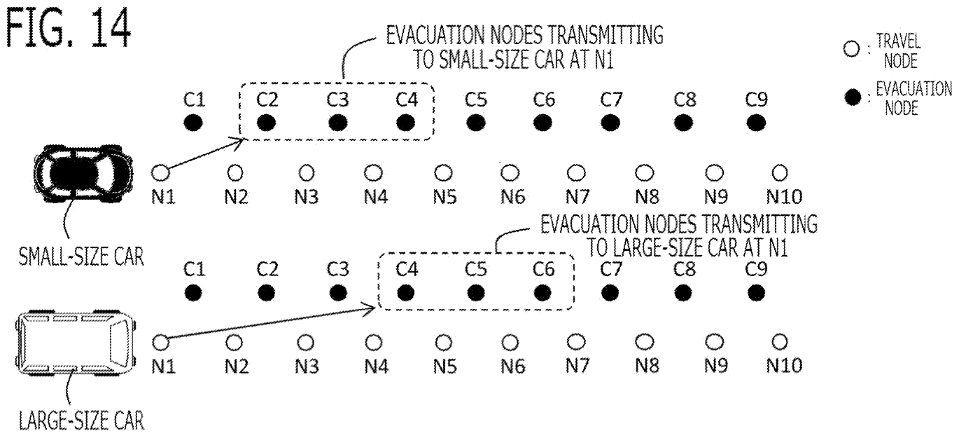

FIG. 14 is a schematic figure for explaining transmission of the evacuation nodes according to the present embodiment. Similarly to Embodiment 1, the vehicle state management unit 15 transmits the evacuation nodes in a distance range located ahead by a set distance from the current position of the object vehicle 1, to the object vehicle 1, whenever the object vehicle 1 travels a determination distance along with the traveling nodes for automatic driving.

In the present embodiment, the vehicle state management unit 15 lengthens the set distance, as a size of the object vehicle 1 becomes large. The vehicle state management unit 15 determines the size of the object vehicle 1, based on the vehicle information (the vehicle type, the vehicle width, the vehicle height, and the like) acquired from the object vehicle 1.

The upper row of FIG. 14 shows a case where the object vehicle 1 is a small-size car. The lower row of FIG. 14 shows a case where the object vehicle 1 is a large-size car. In the upper row and the lower row of FIG. 14, a position where the evacuation nodes are transmitted is the travel node N1. In the upper row of FIG. 14, at the time when the object vehicle 1 of the small-size car reached the travel node N1, the vehicle state management unit 15 transmits the evacuation nodes C2, C3, and C4 corresponding to the traveling nodes for automatic driving N2 to N5 which are located ahead by the set distance which is set for the small-size car from the travel node N1. In the lower row of FIG. 14, at the time when the object vehicle 1 of the large-size car reached the travel node N1, the vehicle state management unit 15 transmits the evacuation nodes C4, C5, and C6 corresponding to the traveling nodes for automatic driving N4 to N7 which are located ahead by the set distance which is set for the large-size car from the travel node N1. The set distance for large-size car is set longer than the set distance for small-size car.

Since the turning radius of the small-size car is comparatively small, it can evacuate to the evacuation nodes comparatively close to the current position. On the other hand, since the turning radius of the large-size car is comparatively large, it can evacuate to the evacuation nodes comparatively far from the current position. Accordingly, the appropriate set distance can be set according to the size of the object vehicle 1, and the evacuation nodes in the appropriate front distance range can be transmitted to the object vehicle 1.

### 3. Embodiment 3

Next, the vehicle control system according to Embodiment 3 will be explained. The explanation for constituent parts the same as those in Embodiment 1 will be omitted. The basic configuration and processing of the vehicle control system according to the present embodiment are the same as those of Embodiment 1. In the present embodiment, the determining method of the evacuation nodes is partially different from Embodiment 1.

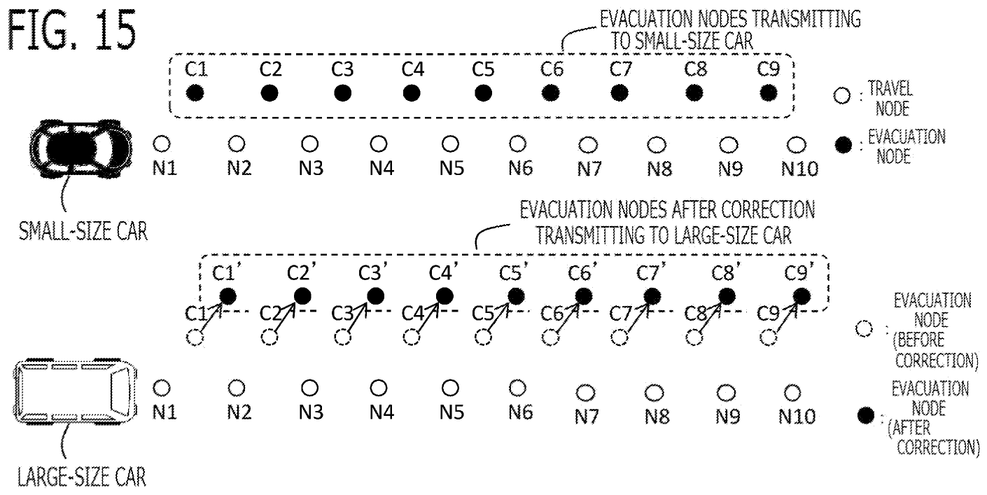

FIG. 15 is a schematic figure for explaining transmission of the evacuation nodes according to the present embodiment. Similarly to Embodiment 1, irrespective of a presence or absence of occurrence of an evacuation cause for evacuating the object vehicle 1, the vehicle state management unit 15 acquires the evacuation nodes corresponding to the traveling nodes for automatic driving, from the evacuation node storage unit 14, and transmits it to the object vehicle 1.

In the present embodiment, the vehicle state management unit 15 corrects the evacuation nodes acquired from the evacuation node storage unit so as to depart from the travel nodes for automatic driving, as a size of the object vehicle 1 becomes large; and transmits the evacuation nodes after correction to the object vehicle 1. The vehicle state management unit 15 determines the size of the object vehicle 1, based on the vehicle information (the vehicle type, the vehicle width, the vehicle height, and the like) acquired from the object vehicle 1.

The upper row of FIG. 15 shows a case where the object vehicle 1 is a small-size car. The lower row of FIG. 15 shows a case where the object vehicle 1 is a large-size car. As shown in the upper row of FIG. 15, when the object vehicle 1 is a small-size car, the vehicle state management unit 15 transmits to the object vehicle 1, without correcting the evacuation nodes acquired from the evacuation node storage unit 14. As shown in the lower row of FIG. 15, when the object vehicle 1 is a large-size car, the vehicle state management unit 15 corrects the evacuation nodes acquired from the evacuation node storage unit 15 so as to depart from the travel nodes for automatic driving, and transmits the evacuation nodes after correction to the object vehicle 1. For example, the evacuation node may be corrected so as to depart from the traveling nodes for automatic driving in the lateral direction by an increment of the vehicle width of the object vehicle 1 from the standard vehicle width. In the present embodiment, as shown in the lower row of FIG. 15, the vehicle state management unit 15 corrects the evacuation nodes acquired from the evacuation node storage unit 14 so as to move forward, as the size of the object vehicle 1 becomes large.

In this way, by correcting the evacuation nodes so as to depart from the travel nodes as the size of the object vehicle 1 becomes large, even if the size of the object vehicle 1 becomes large, it can avoid becoming the disturbance of other vehicles which travel the travel nodes, by the vehicle evacuated to the evacuation nodes. And, by correcting the evacuation nodes so as to move forward as the size of the object vehicle 1 becomes large, the appropriate evacuation nodes corresponding to the large-size car having the large turning radius can be transmitted.

Similarly to Embodiment 1, the vehicle state management unit 15 may transmit the evacuation nodes in a distance range located ahead by a set distance from the current position of the object vehicle 1, to the object vehicle 1, whenever the object vehicle 1 travels a determination distance along with the traveling nodes for automatic driving.

### 4. Embodiment 4

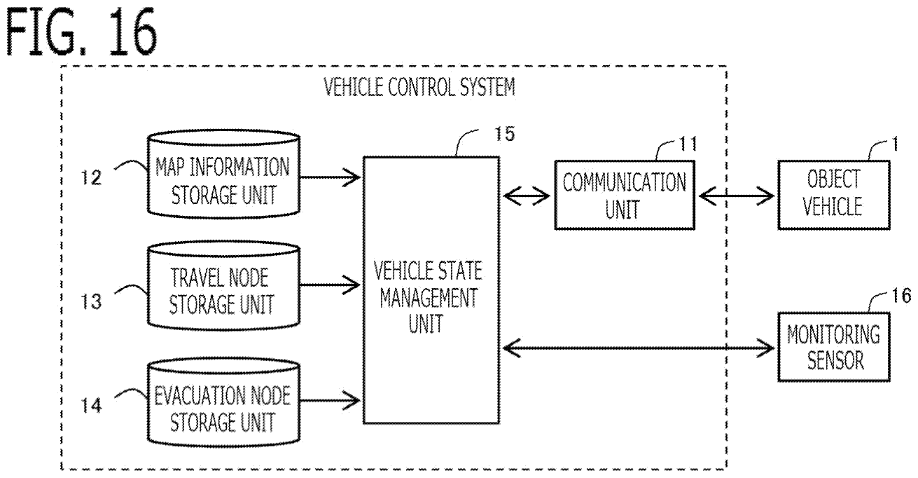

Next, the vehicle control system according to Embodiment 4 will be explained. The explanation for constituent parts the same as those in Embodiment 1 will be omitted. The basic configuration and processing of the vehicle control system according to the present embodiment are the same as those of Embodiment 1. Embodiment 4 is different from Embodiment 1 in that the vehicle control system uses monitoring sensors. FIG. 16 is a schematic block diagram of the vehicle control system.

In the present embodiment, the vehicle state management unit 15 monitors the vehicle state by a plurality of monitoring sensors 16 installed in the control area. As the monitoring sensor 16, a camera, a radar, or the like is used. The monitoring sensor 16 is provided in each place where the vehicle in control area can pass (for example, the travel node, the evacuation node, the parking area, and the entrance and the exit of the parking place). Based on the detection information of the monitoring sensors 16, the vehicle state management unit 15 determines the vehicle information (the size of vehicle, and the like) of the object vehicle 1, and determines the information on the current position, the traveling state, and the like of the object vehicle 1.

According to this configuration, the vehicle control system can acquire information, such as the vehicle information, and the current position, without communicating with the object vehicle 1, and can also monitor the vehicle state in the control area. Accordingly, without depending on communication with the object vehicle 1, accurate information can be acquired autonomously. For example, based on state of each vehicle detected by the monitoring cameras, the evacuation nodes can be selected and corrected.

The acquisition of the vehicle information and the current position by communication between the vehicle control system and each object vehicle which was described in Embodiment 1, and the acquisition of the vehicle information and the current position by the monitoring sensors 16 may be performed at the same time.

According to each above embodiment, the vehicle control system manages positions where each vehicle evacuates, as the evacuation nodes, and transmits the evacuation nodes to the object vehicle, before the evacuation cause occurs. Accordingly, after occurrence of the evacuation cause, the object vehicle 1 can quickly evacuate to the appropriate evacuation place, without waiting for transmission of the evacuation nodes from the vehicle control system. Accordingly, the passage of other vehicles can be prevented from disturbing, and the entering and leaving can be prevented from restricting. The efficiency and reliability of the automatic valet parking system can be improved.

In each above embodiment, there has been explained the case where the control area is the parking place, and the vehicle control system is used for the automatic valet parking system. However, the control area may be an area other than the parking place, for example, an ordinary road, an area in a facility, and the like. Even in this case, the vehicle control system acquires the traveling nodes for automatic driving which makes the object vehicle 1 perform automatic driving from a specified position to a specified position, from the travel node storage unit 13; and transmits it to the object vehicle 1 via the communication unit 11. Then, in the case of making the object vehicle 1 perform automatic driving from the specified position to the specified position, irrespective of a presence or absence of occurrence of an evacuation cause, the vehicle control system acquires the evacuation nodes corresponding to the traveling nodes for automatic driving, from the evacuation node storage unit 14, and transmits it to the object vehicle 1.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1: Object Vehicle, 11: Communication Unit, 12: Map Information Storage Unit, 13: Travel Node Storage Unit, 14: Evacuation Node Storage Unit, 15: Vehicle State Management Unit

1. A vehicle control system comprising at least one processor configured to implement:
a communicator that communicates with an object vehicle which performs an automatic traveling in a control area for controlling;
a map information storage that stores map information of the control area;
a travel node storage that stores travel nodes for performing an automatic driving, in the control area;
an evacuation node storage that stores evacuation nodes for making a vehicle evacuate from the travel nodes and stop in an emergency, in the control area;
a vehicle state manager that
monitors a vehicle state including the object vehicle in the control area,
acquires the map information of the control area from the map information storage,
acquires the travel nodes for automatic driving which makes the object vehicle perform the automatic driving from the travel node storage unit, based on the vehicle state and the map information of the control area, and transmits to the object vehicle via a communicator, and
acquires the evacuation nodes which makes the object vehicle evacuate from the evacuation node storage, and transmits to the object vehicle via the communicator,
wherein, irrespective of a presence or absence of occurrence of an evacuation cause for evacuating the object vehicle, the vehicle state manager acquires the evacuation nodes corresponding to the travel nodes for automatic driving from the evacuation node storage, and transmits to the object vehicle.

2. The vehicle control system according to claim 1,
wherein the vehicle state manager transmits the evacuation nodes in a distance range located ahead by a set distance from a current position of the object vehicle, to the object vehicle, whenever the object vehicle travels a determination distance along with the travel nodes for automatic driving.

3. The vehicle control system according to claim 2,
wherein the vehicle state manager lengthens the set distance, as a size of the object vehicle becomes large.

4. The vehicle control system according to claim 1,
wherein the vehicle state manager corrects the evacuation nodes acquired from the evacuation node storage so as to depart from the travel nodes for automatic driving, as a size of the object vehicle becomes large.

5. The vehicle control system according to claim 1,
wherein the vehicle state manager corrects the evacuation nodes acquired from the evacuation node storage so as to move forward, as a size of the object vehicle becomes large.

6. The vehicle control system according to claim 1,
wherein the vehicle state manager monitors the vehicle state by a plurality of monitoring sensors installed in the control area.

7. The vehicle control system according to claim 1,
wherein the vehicle state manager acquires information on a current position of the object vehicle, and a size of the object vehicle, from the object vehicle, via the communicator.

8. The vehicle control system according to claim 1,
wherein the vehicle state manager acquires information on a current position of the object vehicle, and a size of the object vehicle by a plurality of monitoring sensors installed in the control area.

9. The vehicle control system according to claim 1,
wherein the control area is a parking place which has a plurality of parking areas, and
wherein, when the object vehicle which arrived at an entrance of the parking place is made to enter in the parking area, the vehicle state manager acquires the travel nodes for automatic driving which make the object vehicle perform the automatic driving from the entrance to the parking area, from the travel node storage unit, and transmits to the object vehicle via the communicator;
when the object vehicle which parked in the parking area is made to leave from the parking area, the vehicle state manager acquires the travel nodes for automatic driving which make the object vehicle perform the automatic driving from the parking area to an exit of the parking place, from the travel node storage unit, and transmits to the object vehicle via the communicator; and
when the object vehicle is made to enter in the parking area or leave from the parking area, the vehicle state manager, irrespective of the presence or absence of occurrence of the evacuation cause, acquires the evacuation nodes corresponding to the travel nodes for automatic driving, from the evacuation node storage, and transmits to the object vehicle.
